(19) United States
(12) Patent Application Publication
(10) Pub. No.: US 2003/0167471 A1
(43) Pub. Date: Sep. 4, 2003

(54) System and method for selection of video products that are deliverable on demand

(76) Inventors: Cliff Roth, New York, NY (US); David Ruderman, Brooklyn, NY (US); Keith Walter, Brooklyn, NY (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/090,405

(22) Filed: Mar. 4, 2002

(51) Int. Cl. H04N 7/173; G06F 3/00; H04N 5/445; G06F 13/00

(52) U.S. Cl. 725/87; 725/61; 725/39

(57) ABSTRACT

A system and method for managing series video-on-demand (SVOD) products is described. One implementation of the described device includes the steps of receiving a selection to activate a SVOD guide; retrieving a list of SVOD providers; retrieving display data for each of the SVOD providers included in the list of SVOD providers; and initiating display of the retrieved display data for each of the SVOD providers, wherein a user can select at least one of the SVOD providers.

### FIELD OF THE INVENTION

The present invention relates to video programming guides. In particular, but without limitation, the present invention relates to systems and methods for aiding viewers in selecting video products that are deliverable on demand.

### BACKGROUND OF THE INVENTION

With increases in bandwidth and improvements in data delivery systems, consumers can now receive hundreds of channels of video data. To help consumers sort through the vast number of programs being offered, several companies have developed and deployed electronic programming guides (“EPGs”). The earliest EPGs were not interactive and, thus, offered the consumer little program data and an overall poor experience. With the deployment of digital cable and satellite TV systems, companies began offering interactive EPGS. These EPGs have proved useful, and almost essential, in helping consumers sort through the hundreds of available programs and have been widely adopted by the TV industry. One of the most common interactive EPGs involves a grid arranged by time and channel. The individual grid cells correspond to programs being offered by a particular channel at a particular time. Consumers can select particular programs by selecting the appropriate grid cells. An example of this type of EPG is produced by Gist Communications, Inc. (84 Wooster Ave., Suite 604; New York, N.Y. 10012).

Recently, technology has been developed to provide consumers with video on demand (“VOD”) through existing cable lines, satellite networks and DSL. VOD provides consumers with the ability to choose from several thousand titles and have playback begin at any time. An efficient and convenient guide is essential to helping consumers sort through the vast number of VOD offerings.

Unlike scheduled programming, VOD offerings cannot be logically arranged according to start time. Thus, the grid format used by present EPGs is not helpful because VOD programs start whenever the consumer desires. Additionally, text-based listing methods are not only unattractive but also generally ineffective in the video environment. Accordingly, a system and method are needed to help consumers sort and select VOD products.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one exemplary embodiment of the present invention, a set-top box (STB) is connected to a TV (or other display device) and to a data network. The STB can receive scheduled programming data from the cable provider and display that programming on the TV. The STB can also receive and display VOD products stored at a network-attached VOD provider.

As previously described, the consumer can view an EPG for the scheduled programming. The EPG application software, for example, can reside on the STB and the data to be rendered by the EPG application can be stored at an EPG provider and provided to the STB at appropriate times. In other embodiments, EPG data is stored at both the EPG provider and the STB.

When the consumer chooses to view a VOD product such as a movie or an episode of a series, the STB can provide a VOD guide for display on the TV. The application software responsible for driving the VOD guide can be stored on the STB in the form of, for example, a Java application, and the data for the VOD guide can be stored at a VOD guide provider. Alternatively, the STB could include a rendering engine such as a browser and the VOD guide provider could serve pages to the STB.

Because VOD products can be viewed at any time, VOD guides are not restricted to an organization according to start time. Thus, in one embodiment of the present invention, available VOD products are organized according to categories such as genre. Each genre can then be linked to its own sorting criteria, e.g., subcategories, and VOD products can be associated with one or more of these criteria. As the consumer navigates the VOD guide and selects categories and subcategories, appropriate VOD products can be displayed in a display window.

In one embodiment of the present invention, the STB displays a VOD guide arranged in two sections: a sorting section and a product display section. The sorting section includes the categories and/or subcategories in which the VOD products are grouped. The product display section includes a set of display windows that include images linked to the VOD products in a selected category/subcategory combination. In one particular implementation, the product display section is divided into VOD product windows corresponding to available VOD products. Each VOD product window is configured to display an image associated with the corresponding VOD product. For example, a product window could display the movie poster or scenes from the corresponding VOD product. These product windows can also be tied to functionality that can initiate the playback of that VOD product. For example, when a consumer selects a certain product window, the STB can transmit a signal to the VOD provider to begin playback of the associated VOD product.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a video delivery system in accordance with the principles of the present invention;

FIG. 2 illustrates a VOD guide in accordance with the principles of the present invention;

FIG. 3 is a flowchart of one method for generating a VOD guide in accordance with the principles of the present invention;

FIG. 4 illustrates a series VOD (SVOD) guide in accordance with the principles of the present invention;

FIG. 5 illustrates a portion of a SVOD guide in accordance with the principles of the present invention;

FIG. 6 illustrates another portion of a SVOD guide in accordance with the principles of the present invention; and

FIG. 7 illustrates a personal VOD (PVOD) guide in accordance with the principles of the present invention.

### DETAILED DESCRIPTION

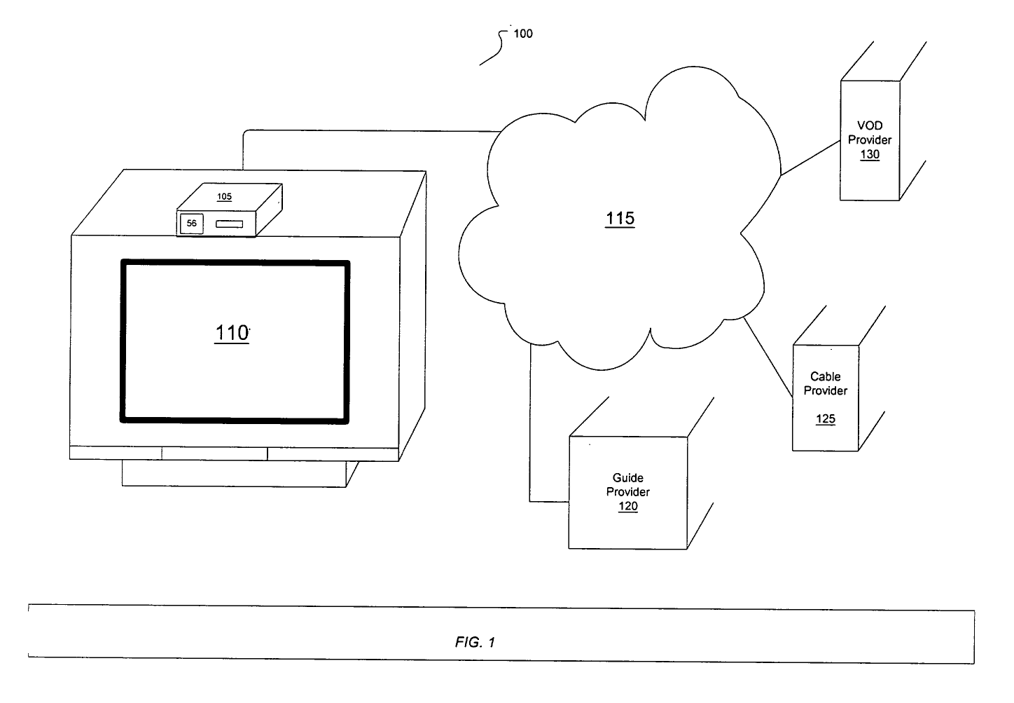

Referring now to the drawings, where like or similar elements are designated with identical reference numerals throughout the several views, and referring in particular to FIG. 1, it illustrates a video delivery system 100 in accordance with the principles of the present invention. In this embodiment, a STB 105 is connected to a TV 110 and a network 115. Scheduled programming (from a cable provider 125) and VOD products (from a VOD provider 130), e.g., movies, are sent through the network 115 to the STB 105 for display on the TV 110. EPGs and VOD guides arc also sent through the network 115 to the STB 105. Although the STB 105 is shown as a separate unit from the TV 110, embodiments of the present invention include an integrated TV 110 and STB 105, thus, STB also refers to the functionality of a STB. Exemplary STBs 105 include products by Liberate (2 Circle Star Way, San Carlos, Calif. 94070) and Open TV (401 East Middlefield Road, Mountain View, Calif. 94043.) Generally, these STBs 105 include a middleware layer that includes a Java engine and a browser functionality.

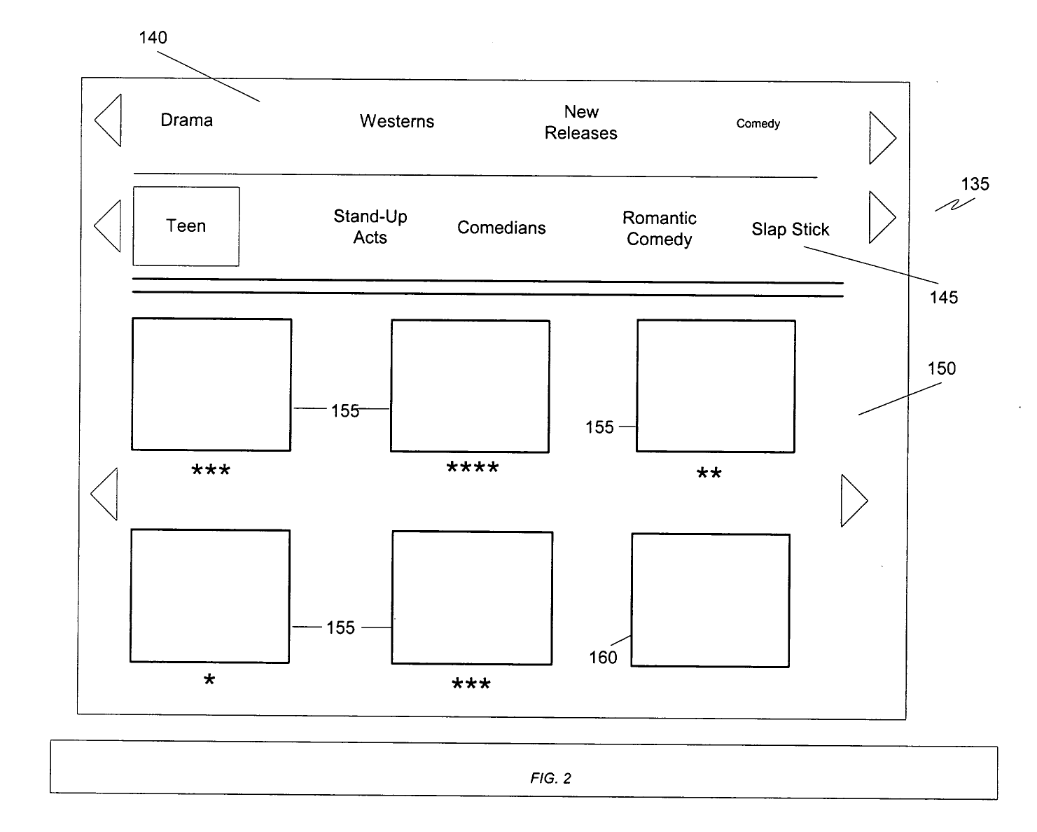

When the consumer instructs the STB 105 to display a VOD guide, the STB 105 executes an application program stored at the STB 105. The STB 105, as directed by the application program, can retrieve data from the VOD guide provider 120. Using the retrieved data, the STB 105 can display a VOD guide similar to the VOD guide shown in FIG. 2. In other embodiments the STB 105 can use both data from the VOD guide provider 120 and data stored local to the STB 105 to generate the VOD guide (or any other display device).

Referring now to FIG. 2, the VOD guide 135 shown therein is divided into three portions: genre sorting bar 140, subcategory sorting bar 145, and product display section 145. Referring first to the genre sorting bar 140, it presents the consumer with the option to sort available VOD products by genre. For example, the consumer can select from Drama, Westerns, New Releases, Comedy, Sci-Fi, etc. If all of the genres are not visible on the displayed screen, the other genres can be reached through scrolling.

In the VOD guide 135 of FIG. 2, the consumer has selected the “Comedy” genre as indicated by the box around “Comedy.” In response to the consumer selecting “Comedy,” the STB 105 displays in the subcategory sorting bar 145 the subcategories unique to “Comedy.” As the consumer scrolls through the different subcategories, VOD products corresponding to the selected category can be displayed. For example, when the consumer selects the “Teen” subcategory, related VOD product indicators, e.g., movie images, can be displayed in the VOD product windows 155 included in the product display section 150. The data displayed in the window can include text, image files and/or streaming media. For example, the window could include images taken from movie scenes or advertisements associated with the particular VOD product.

In many cases, the number of available VOD products in a category/subcategory combination will exceed the number of product display windows 155 that can be displayed at one time. Thus, the available VOD products may be further ranked so that the most relevant titles are displayed first. The VOD products, for example, can be ranked within a category/subcategory combination according to consumer-selected criteria or other criteria. For example, the consumer could indicate that the VOD products should additionally be sorted according to release date. Thus, within the “Comedy-Teen” category/subcategory, the available products would be sorted by release data. The other products can be viewed by scrolling the product display section 150. In other embodiments, the consumer could choose to have previously viewed movies shown last or certain types of products not shown. For example, movies with “R” ratings could be blocked so that they do not even appear in a VOD product window 155.

Depending upon the embodiment, either the STB 105 or the VOD guide provider 130 can sort the available VOD products. Assuming that the STB 105 is responsible for sorting, the STB 105 would compile a list of available VOD products for a particular category/ subcategory combination. The STB 105 could pull this list from local memory or request the list from the VOD guide provider 130. When the list is pulled from local memory, the STB 105 may attempt to prefetch any image data related to the VOD products, which can include still images, streaming video and/or streaming audio.

When the consumer finds a VOD product of interest, he can select that product and the STB 105 can display a page that offers the consumer information about the select product, payment information, and other data that may be of interest. This page can also offer the consumer the option of purchasing the VOD product for immediate or subsequent viewing. If the user chooses to view the VOD product, the STB 105 can send an appropriate message to the VOD provider so that the VOD provider can provide the product as requested.

Still referring to FIG. 2, the VOD guide also includes a streaming media window 160 that can display most any type of streaming media, including scheduled programming. In one embodiment, video related to new releases or coming attractions could be played in the streaming media window 160 while the available VOD products are listed in the VOD product window 155. As the consumer scrolls the VOD product windows left or right, the streaming media window 160 could be unchanged. In another embodiment, the streaming media window 160 is linked to the VOD product that the consumer has selected. In this case, the streaming media window 160 could display still images, streaming video, or advertisements related to that VOD product or to similar VOD products.

The number of VOD product windows 155 displayed in the product display section 155 of the VOD guide can vary according to consumer preferences. The VOD product windows, for example, can be sized by the consumer so that more or fewer VOD product windows 155 are shown on a single screen. In another embodiment, the number of VOD product windows 155 displayed depends on the size of the consumer's TV. For example, more VOD product windows 155 could be displayed on a larger TV. The consumer can either inform the STB 105 of the size of the TV or the STB 105 can discover the size of the TV.

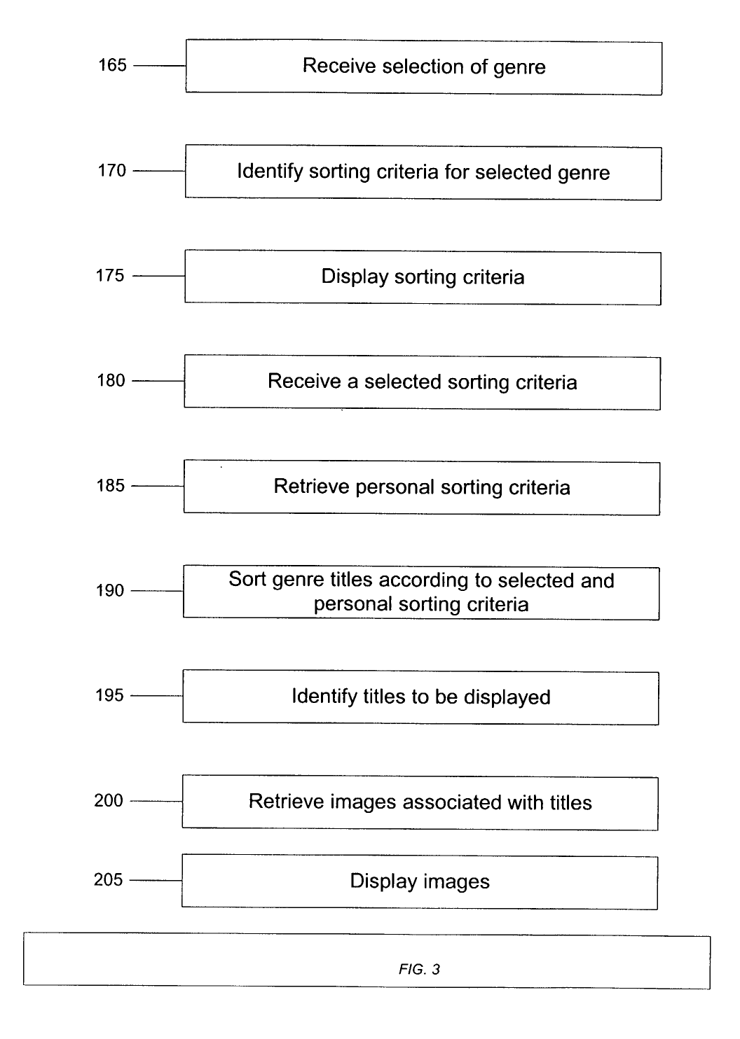

Referring now to FIG. 3, it is a flowchart of one method for generating a VOD guide such as the one shown in FIG. 2. In this method, the STB 105 (or the VOD guide provider) initially receives a genre (or some other categorization) selection (step 165). The STB 105 then identifies the appropriate sorting criteria for the selected genre (step 170). Exemplary sorting criteria include: action, adult content, awards, box office revenue, critical acclaim, romantic content, humor, special effects, suspense, violence, hit songs, and popular celebrities. Each VOD offering can be ranked according to the various sorting criteria. For example, Terminator, could receive a high ranking, e.g., three out of four stars, for action, box office revenue, special effects and violence. Similarly, it could receive a low ranking for romantic content and hit songs. The VOD guide provider or a third party can rank each VOD offering according to the sorting criteria and store that information for subsequent provision to the STB 105.

The sorting criteria corresponding to the selected category are displayed on the TV so that the consumer can make a selection (steps 175 and 180). Once the consumer has made a selection, the appropriate VOD product indicators can be identified. The VOD products can be displayed in order of the rankings, e.g., number of stars assigned by the VOD guide provider or other party. In another embodiment, the consumer's sorting preferences are retrieved and applied to the identified VOD products. Other sorting criteria can be used in addition to or rather than the consumer's sorting criteria to aid in determining which VOD product indicators to list first (step 185).

Regardless of which sorting methods are used, a first group of VOD product indicators can be identified (steps 190 and 195). The number of indicators in that group depends on the arrangement of the VOD guide but is generally linked to the number of indicators that can be displayed at one time. The STB 105 can determine if information regarding the identified VOD product indicator is cached locally, such as on a personal video recorder (PVR). If the information is not stored locally, then the STB 105 can generate a request and send it to the VOD guide provider, which can respond with the appropriate data (step 200). The STB 105 can then display that data (step 205). For example, the data could be displayed in the VOD guide 135 shown in FIG. 2.

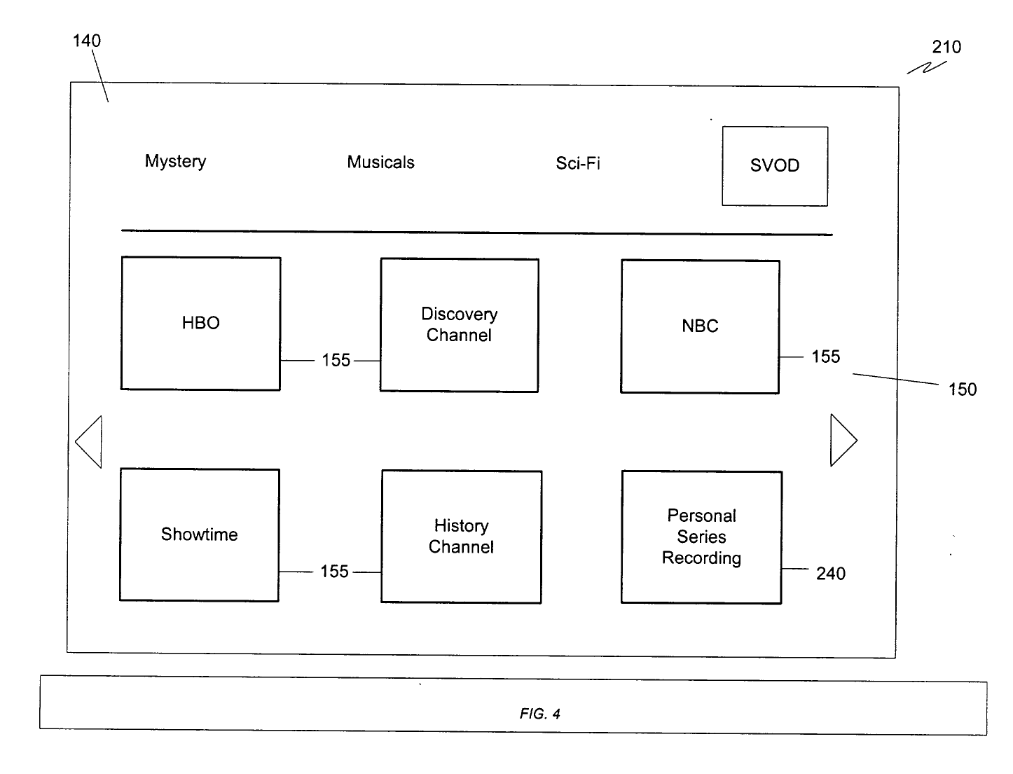

Referring now to FIG. 4, it illustrates a SVOD version 210 of a VOD guide. In this embodiment, the SVOD guide includes a single sorting bar 215. This sorting bar 215 includes genre selections and a series VOD (SVOD) selection. When the consumer selects the SVOD option, the STB 105 can retrieve a list of SVOD providers and their associated indicators, such as channel logos. These indicators can then be arranged and displayed, for example, in the format shown in FIG. 4. In this embodiment, the list of SVOD providers can be scrolled left and/or right. The list can be arranged in a variety of ways, including alphabetically, most recently viewed, most popular, etc.

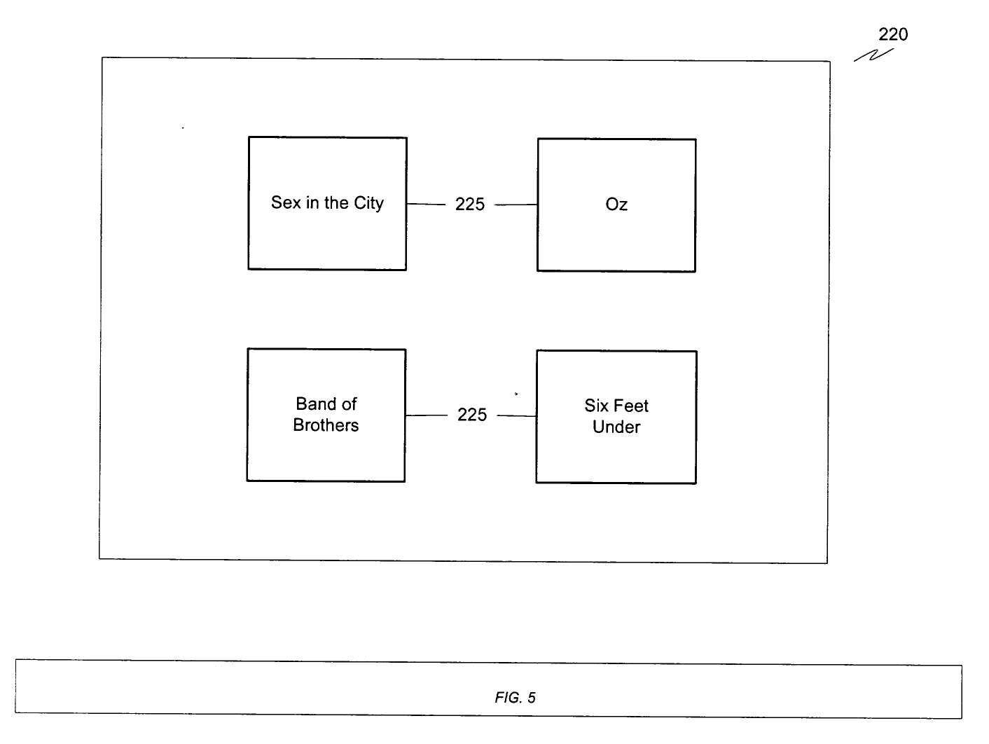

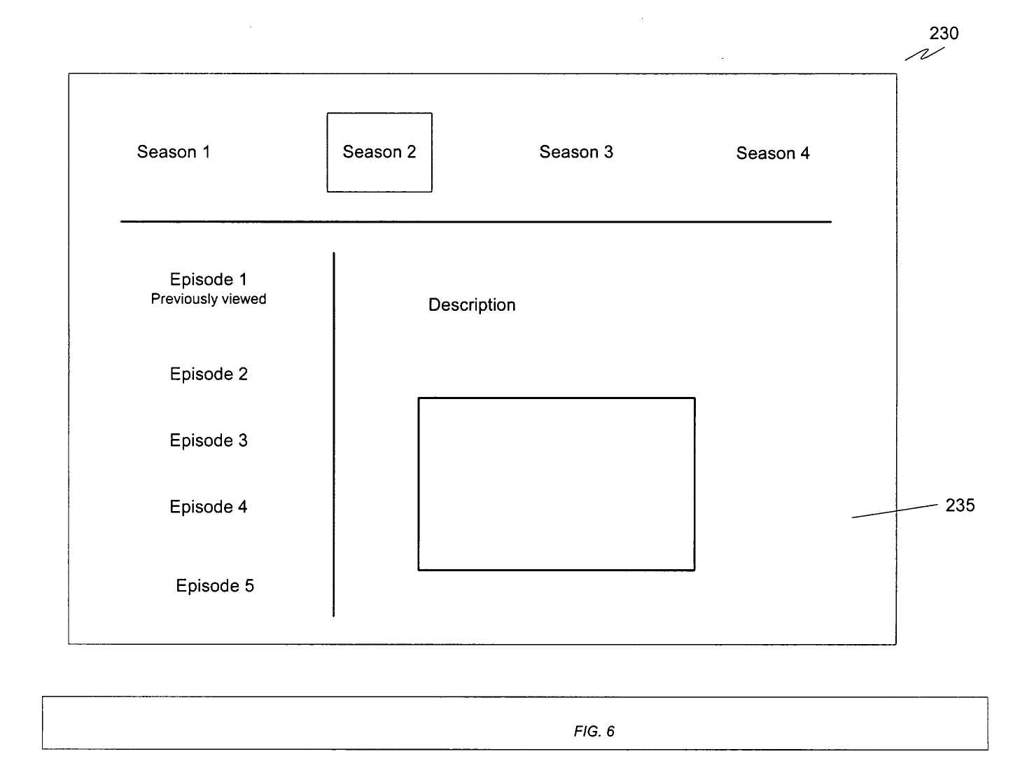

Responsive to a consumer selecting a particular SVOD provider, a subsequent page can be displayed. This subsequent page can display the individual series associated with the VOD provider. For example, if the consumer selects HBO™, then the next page (shown in FIG. 5) could show SVOD product indicators 225 associated with each available HBO series. In one embodiment, SVOD product windows 225 can display single images or cycle through several images related to the corresponding series. When the consumer selects one of the series, such as Sex in the City, the STB 105 can display a page associated with that show, as shown in FIG. 6.

Responsive to Sex in the City being selected, the consumer, for example, can be presented with a page 230 that lists the series' seasons. When a particular season is selected, the episodes for that season can be displayed. In FIG. 6, for example, episodes 1-5 are listed for season 2. The consumer has previously viewed episode 1, and it is marked accordingly. By marking the previously viewed episodes, the VOD guide 135 can help the consumer select the next unviewed episode in a series. In one embodiment of the present invention, the VOD guide 135 automatically recommends the next episode in the series based upon the consumer's prior viewings.

When an episode is selected, information and/or images corresponding to that episode can be displayed on the same page 230 in, for example, a separate frame 235. If the consumer wants to view the selected episode, an appropriate action button on the displayed page can be selected. The STB 105 then passes the information to the VOD provider 130 that is responsible for delivering the content.

Referring again to FIG. 4, the VOD guide illustrated therein includes a personal series recording (PSR) window 240. The PSR window 240 is linked to a storage device that stores programming, video, or other data responsive to a consumer's request. For example, the PSR window 240 could be linked to a personal video recorder (PVR). In operation, the consumer could instruct the PVR (possibly through the VOD guide) to record the entire season of Sex in the City. As the PVR records each episode, it could catalog the data related to the show, e.g., episode name and description, and present it in a format similar to that shown in FIG. 6. Additionally, the VOD guide could determine which episodes are missing from the consumer's personal recordings by comparing the list of recordings against a list of available episodes. In essence, the personal series recording option allows the consumer to build a local SVOD system and to interface with that system in a fashion similar to the method for interfacing with the remote SVOD provider. Notably, in one embodiment the actual recording is performed at a head-end system.

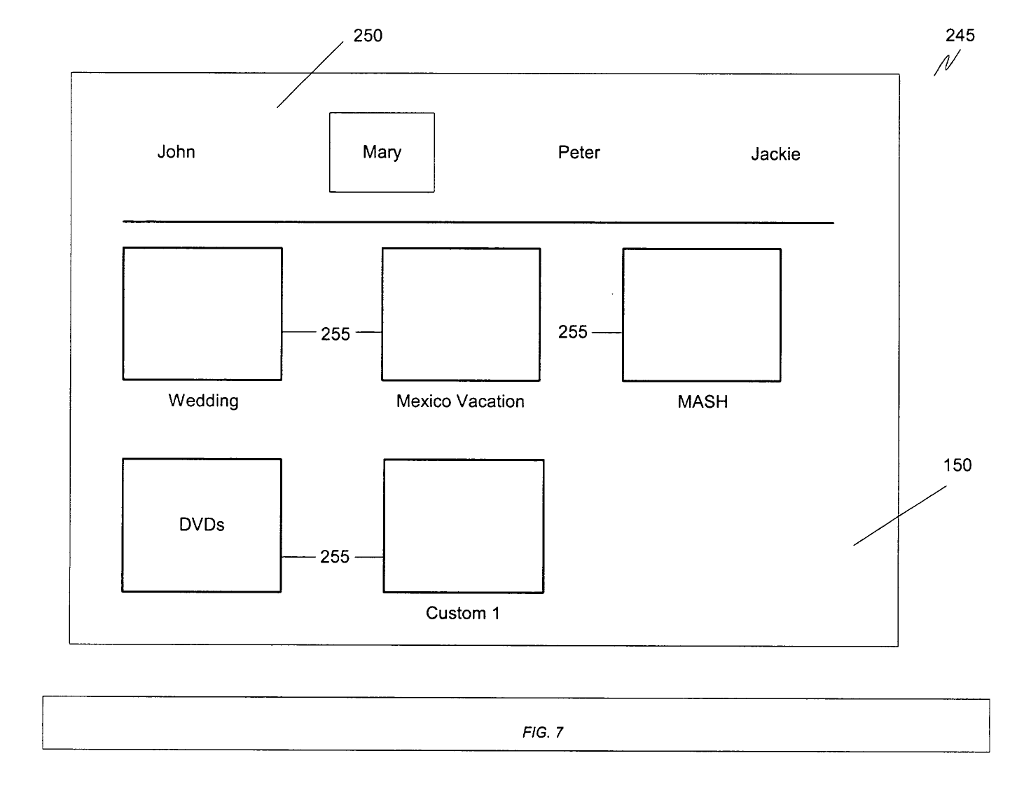

Referring now to FIG. 7, it illustrates a personal VOD (PVOD) guide 245 that could be displayed in response to the consumer selecting the PSR window 240 shown in FIG. 4. This page includes a sorting bar 250 that is customizable by the consumer. For example, the bar 250 could have categories based on family members, genres, types of data, etc. As the user scrolls across the available categories, the windows 255 associated with that category are populated. The data types linked to the windows 255 are not limited to video products. For example, digitized photographs can be stored local to the STB 105 and categorized in a way defined by the consumer. In one embodiment of the present invention, the STB 105 can even cause certain data, such as wedding photos, to be backed up at a remote site.

Although the present invention has been generally described with regard to cable systems and STBs 105, several other embodiments are available. For example, actions described as performed by the STB 105 can be performed remotely at the VOD guide provider 120. Additionally, Java, JavaScript, HTML, and XML can be used to implement variations of the present invention. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing a plurality of video on demand (VOD) products, the method comprising:
identifying a plurality of VOD product categories;
initiating display of at least a portion of the plurality of identified VOD product categories;
receiving an indication of a selected one of the plurality of VOD product categories;
identifying a plurality of VOD product subcategories, wherein the plurality of VOD product subcategories are associated with the selected one of the plurality of VOD product categories;
receiving an indication of a selected one of the plurality of VOD product subcategories;
identifying a plurality of VOD products associated with the selected one of the plurality of VOD product subcategories;
retrieving a plurality of VOD product identifiers, each of the plurality of product identifiers associated with one of the identified plurality of VOD products; and
initiating display of at least a portion of the retrieved plurality of VOD product identifiers.

2. The method of claim 1, wherein identifying the plurality of VOD product categories comprises:
retrieving a list of VOD categories from a memory local to a rendering system, wherein the rendering system is configured to initiate display of the retrieved image data.

3. The method of claim 1, wherein identifying the plurality of VOD product categories comprises:
retrieving a list of VOD categories from a VOD provider.

4. The method of claim 1, wherein initiating display of the retrieved image data comprises:
initiating display of the retrieved image data in a guide-display section of a display device, wherein the guide-display section is configured to be horizontally scrollable.

5. The method of claim 1, further comprising:
determining a characteristic of a display device, wherein the display device is configured to display the retrieved image data.

6. The method of claim 5, wherein the number of VOD product identifiers included in the at least a portion of the VOD product identifiers corresponds to the determined characteristic.

7. The method of claim 1, further comprising:
retrieving a user-defined customization factor;
wherein the number of VOD product identifiers included in the at least a portion of the VOD product.identifiers corresponds to the user-defined customization factor.

8. The method of claim 1, further comprising:
retrieving a user-defined ranking criteria; and
sorting the identified plurality of VOD products according to the retrieved user-defined ranking criteria;
wherein the plurality of VOD product identifiers associated with the sorted plurality of VOD products is displayable according to the sorting.

9. The method of claim 1, further comprising:
providing an indication of the selected category and subcategory to a VOD guide provider;
identifying, at the VOD guide provider, the plurality of VOD products associated with the selected category and subcategory; and
providing a list of the plurality of VOD products to a rendering system.

10. The method of claim 9, wherein providing the list of the plurality of VOD products to the rendering system comprises:
providing a list of the plurality of VOD products to a set-top box.

11. The method of claim 9, further comprising:
determining whether any of the plurality of VOD product identifiers associated with VOD products included in the list are stored local to the rendering system; and
responsive to the VOD product identifier for a first of the plurality of VOD products not being stored local to the rendering system, requesting that the VOD guide provider provide the VOD product identifier for the first of the plurality of VOD products.

12. The method of claim 1, further comprising:
retrieving a viewing restriction; and
determining whether the viewing restriction applies to any of the plurality of VOD products associated with the selected one of the plurality of VOD product categories.

13. The method of claim 12, wherein initiating display of the retrieved image data comprises:
initiating display of only the retrieved plurality of VOD product identifiers that comply with the viewing restriction.

14. A method for managing a plurality of VOD products, the method comprising:
receiving an indication of a VOD product category;
identifying a plurality of VOD indicators corresponding to the VOD product category;
assigning a priority to each of the plurality of VOD indicators;
identifying a set of the VOD indicators, wherein the set of the VOD indicators is identified according to the priority assigned to each of the plurality of VOD indicators; and
initiating display of the VOD indicators included in the set of VOD indicators.

15. The method of claim 14, further comprising:
generating a plurality of VOD product display blocks, wherein each of the plurality of VOD product display blocks corresponds to the VOD indicator for each of the VOD indicators included in the set of VOD indicators;
wherein initiating display of the indicators comprises:
initiating display of at least one of the plurality of VOD product display blocks.

16. The method of claim 14, further comprising:
sorting the plurality of VOD indicators according to a user-defined criteria.

17. The method of claim 16, wherein the user-defined criteria is based upon the rating of the VOD product associated with each of the plurality of VOD indicators.

18. The method of claim 16, further comprising:
identifying a first of the plurality of VOD indicators that does not comply with the user-defined criteria; and
removing the first of the plurality of VOD indicators from the identified plurality of VOD indicators such that display of the VOD product indicator associated with the first of the plurality of VOD indicators is not initiated.

19. A method for managing series video-on-demand (SVOD) products, the method comprising:
receiving a selection to activate a SVOD guide;
retrieving a list of SVOD providers;
retrieving display data for each of the SVOD providers included in the list of SVOD providers; and
initiating display of the retrieved display data for each of the SVOD providers, wherein a user can select at least one of the SVOD providers.

20. The method of claim 19, further comprising:
ranking the SVOD providers included in the list according to a ranking criteria;
wherein initiating display comprises:
rendering the display data for a higher ranking SVOD provider before rendering the display data for a lower ranking SVOD provider.

21. The method of claim 19, further comprising:
identifying a SVOD provider that corresponds to a screening criteria.

22. The method of claim 21, wherein rendering comprises:
initiating display of the retrieved display data for SVOD providers other than the identified SVOD provider that corresponds to the screening criteria.

23. The method of claim 19, further comprising:
receiving a selection of SVOD provider included in the list of SVOD providers; and
retrieving a list of available SVOD products corresponding to the selected SVOD provider.

24. The method of claim 23, further comprising:
receiving a selection of a SVOD product included in the list of available SVOD products; and
initiating display of a list of available seasons for the selected SVOD product.

25. The method of claim 24, further comprising:
receiving a selection of a season included in the list of available seasons; and
initiating display of a list of available episodes for the selected season and selected SVOD product.

26. The method of claim 25, further comprising:
receiving a selection of an episode included in the list of available episodes.

27. The method of claim 26, further comprising:
retrieving episodic data related to the selected episode; and
initiating display of the retrieved episodic data.

28. A system for managing series video-on-demand (SVOD) products, the method comprising:
means for receiving a selection to activate a SVOD guide;
means for retrieving a list of SVOD providers;
means for retrieving display data for each of the SVOD providers included in the list of SVOD providers; and
means for initiating display of the retrieved display data for each of the SVOD providers, wherein a user can select at least one of the SVOD providers.

29. The system of claim 28, further comprising:
means for ranking the SVOD providers included in the list according to a ranking criteria;
wherein the means for initiating display comprises:
means for rendering the display data for a higher ranking SVOD provider before rendering the display data for a lower ranking SVOD provider.
